(19) United States
(12) Patent Application Publication
(10) Pub. No.: US 2024/0017292 A1
(43) Pub. Date: Jan. 18, 2024

(54) METHODS AND APPARATUS OF POWER REGULATION FOR A TRANSDUCER

(71) Applicant: Texas Instruments Incorporated, Dallas, TX (US)

(72) Inventors: David Magee, Allen, TX (US); James Griffin, Garland, TX (US); Felipe Garza, III, Dallas, TX (US)

(21) Appl. No.: 17/865,710

(22) Filed: Jul. 15, 2022

(51) Int. Cl. B06B 1/02; G02B 27/00; B08B 7/02; B08B 13/00

(52) U.S. Cl. CPC B06B 1/0215; G02B 27/0006; B08B 7/028; B08B 13/00; B06B 2201/70

(57) ABSTRACT

An example apparatus operable to provide power to a transducer via a regulator output, the power regulator comprising: filter circuitry including a filter input and a filter output, the filter output coupled to the regulator output; amplifier circuitry including an amplifier input and an amplifier output, the amplifier output coupled to the filter input; sensing circuitry including a sensing input and a sensing output, the sensing input coupled to the filter output and the regulator output; and a controller including a controller input coupled to the sensing output and including a controller output coupled to the amplifier input, the controller configured to: supply an excitation signal to the amplifier circuitry to cause the amplifier circuitry to supply the power based on the excitation signal; estimate a magnitude of the power based on measurements of current and voltage at the filter output.

### RELATED APPLICATION

The present application is related to: (a) U.S. Pat. No. 10,384,239, titled “Methods and Apparatus for Ultrasonic Lens Cleaning Using Configurable Filter Banks”, issued on Aug. 20, 2019, (b) U.S. Pat. No. 10,682,675, titled “Ultrasonic lens cleaning system with impedance monitoring to detect faults or degradation”, issued on Jun. 16, 2020; (c) U.S. Pat. No. 10,695,805, titled “Control System for a Sensor Assembly”, issued on Jun. 30, 2020, and (d) U.S. Patent Application ______, titled “ULTRASONIC LENS CLEANING SYSTEM WITH CALIBRATION”, Attorney Docket Number T101606US01, filed on Jul. 15, 2022, all of which are hereby incorporated herein by reference in their entireties.

### TECHNICAL FIELD

This description relates generally to power regulation, and more particularly to methods and apparatus of power regulation for a transducer.

### BACKGROUND

A transducer is an electrical component capable of converting electrical energy into mechanical energy and vice versa. In some applications, an electrical signal of a frequency and amplitude may be supplied to a transducer to cause vibrations. See, for example, U.S. Pat. Nos. 10,682,675; 10,384,239 and 10,695,805 which are hereby incorporated by reference in their entirety. As transducer technology advances, applications of transducer technologies have become increasingly complex and advanced. For example, a transducer may be coupled to a cover for a camera lens to vibrate the lens cover to remove contaminants from obstructing a field of view of a camera.

### SUMMARY

For methods and apparatus of power regulation for a transducer, an example apparatus operable to provide power to a transducer via a regulator output, the power regulator comprising: filter circuitry including a filter input and a filter output, the filter output coupled to the regulator output; amplifier circuitry including an amplifier input and an amplifier output, the amplifier output coupled to the filter input; sensing circuitry including a sensing input and a sensing output, the sensing input coupled to the filter output and the regulator output; and a controller including a controller input coupled to the sensing output and including a controller output coupled to the amplifier input, the controller configured to: supply an excitation signal to the amplifier circuitry to cause the amplifier circuitry to supply the power based on the excitation signal; estimate a magnitude of the power based on measurements of current and voltage at the filter output; and modify the excitation signal based on the estimate of the magnitude of the power.

### BRIEF DESCRIPTION OF THE DRAWINGS

FIG. 1 is a block diagram of an example lens cleaning system including an example power regulator and an example lens cover system.

FIGS. 2A and 2B are an example schematic diagram of the power regulator of FIG. 1 including first example controller circuitry configured to estimate power consumed by the lens cover system of FIG. 1.

FIG. 3 is a schematic diagram of second example controller circuitry configured to estimate power supplied and estimate a phase angle between current being supplied and voltage being supplied by the power regulator of FIG. 1.

FIG. 4 shows illustrative examples of waveforms generated by the power regulator of FIGS. 1, 2A, and 2B to power the lens cover system of FIG. 1.

FIG. 5 is a flowchart representative of an example process that may be performed using machine readable instructions that can be executed and/or hardware configured to implement the first controller circuitry of FIG. 2A, and/or, more generally, the lens cleaning system of FIG. 1 to modify power supplied to increase efficiency and supply power of a target magnitude.

FIG. 6 is a flowchart representative of an example process that may be performed using machine readable instructions that can be executed and/or hardware configured to implement the first controller circuitry of FIG. 2A, and/or, more generally, the lens cleaning system of FIG. 1 to modify power supplied to increase efficiency, supply power of a target magnitude, and remove contaminants.

FIG. 7 is a flowchart representative of an example process that may be performed using machine readable instructions that can be executed and/or hardware configured to implement the second controller circuitry of FIG. 3, and/or, more generally, the lens cleaning system of FIG. 1 to modify power supplied to increase efficiency, supply power of a target magnitude, and remove contaminants.

FIG. 8 is a block diagram of an example processing platform including processor circuitry structured to execute the example machine readable instructions and/or the example operations of FIGS. 5-7 to implement the power regulator of FIGS. 1, 2A, and 2B.

The same reference numbers or other reference designators are used in the drawings to designate the same or similar (functionally and/or structurally) features.

### DETAILED DESCRIPTION

A transducer is a component capable of converting electrical energy into mechanical energy and vice versa. In some applications, an electrical signal having a frequency and an amplitude may be supplied to a transducer to cause vibrations. The frequency and amplitude of the electrical signal are selected to supply power to the transducer, which causes the transducer to vibrate. A transducer may be mechanically coupled to a medium (e.g., a plastic cover, a glass panel, etc.) to transfer physical vibrations to the medium. In applications, such as a microphone, a transducer is configured to convert sound waves vibrating a known medium into an electrical signal, which may be sampled to create digital representations of the sound waves. As transducer technologies and methods of manufacture advance, transducer technologies are becoming increasingly complex. For example, a transducer may be coupled to a camera lens or camera lens cover to vibrate the camera lens cover to remove contaminants obstructing a field of view of a camera.

Transducer operation varies depending on an electrical impedance of the transducer, which depends on several factors including environmental and system conditions (e.g., aging, stress). An impedance of a transducer varies based on the medium being coupled to the transducer. For example, as stress is applied to the medium, the impedance of the transducer may vary based on which material the medium is manufactured from or a temperature of the environment.

Power regulators, configured to supply power to a transducer, may account for variations in the impedance of the transducer by modifying the frequency of the electrical signal supplied to the transducer. The impedance of an ultrasonic transducer includes a resistive component and a reactive component. The resistive component corresponds to energy that is converted to useful power, referred to as true power, during vibrations. The reactive component corresponding to energy that is converted to wasted power, referred to as reactive power, during vibration. In some applications, such as an ultrasonic lens cleaner, the true power is maximized at a resonant frequency of vibrations, which corresponds to an increase in efficiency of the lens cleaner. In such an application, the reactive power is minimized at the resonant frequency of vibration. The magnitude of the resistive and reactive components may be varied by modifying a frequency of power being supplied to the transducer to a frequency above or below the resonant frequency. Such resistive and reactive components of an impedance are represented by a phase angle or a phase difference. The phase difference of the transducer circuitry varies as the resistive component and the reactive component of the impedance responds to a frequency of power being supplied. The efficiency of power regulators varies as a result of the variations in the impedance. In addition, it may result in variations in the physical operating conditions of the transducer, such as a decrease in vibrations or reduction of a power factor value. Advanced transducer applications require a power regulator capable of efficient and adaptable operations, such that power supplied by the power regulator compensates for variations in an impedance of the transducer.

Example methods and apparatus of power regulation for a transducer described herein include power regulator circuitry configured to modify a frequency and an amplitude of an excitation signal used to supply power to a transducer. In some described examples, the power regulator circuitry includes controller circuitry configured to estimate power supplied to the transducer. The power regulator modifies an excitation frequency and amplitude of an excitation signal used to determine the power supplied to a transducer to adjust for variations in the impedance. The power regulator modifies the excitation signal based on a difference between the estimated power supplied to the transducer and a target magnitude of power to be supplied. The power regulator may modify the excitation signal to increase power efficiency, decrease power consumption, and/or account for variations to an impedance of the transducer.

The power regulator circuitry described herein is configured to supply power to an ultrasonic lens cleaner including a transducer. The transducer is configured to convert electrical energy into vibrations, which cause contaminants (e.g., dust, water, dirt, etc.) covering the lens to vibrate off of the lens cover. The impedance of the transducer varies as contaminants are accumulated on or removed from the lens cover. The power regulator circuitry may be configured to estimate a phase difference between a current measurement and voltage measurement of the power being supplied to the transducer. The power regulator circuitry may determine voltage parameters (e.g., frequency) of the power being supplied to the transducer to increase power efficiency, modify power consumption, and/or modify vibrations of the transducer to maximize cleaning operations.

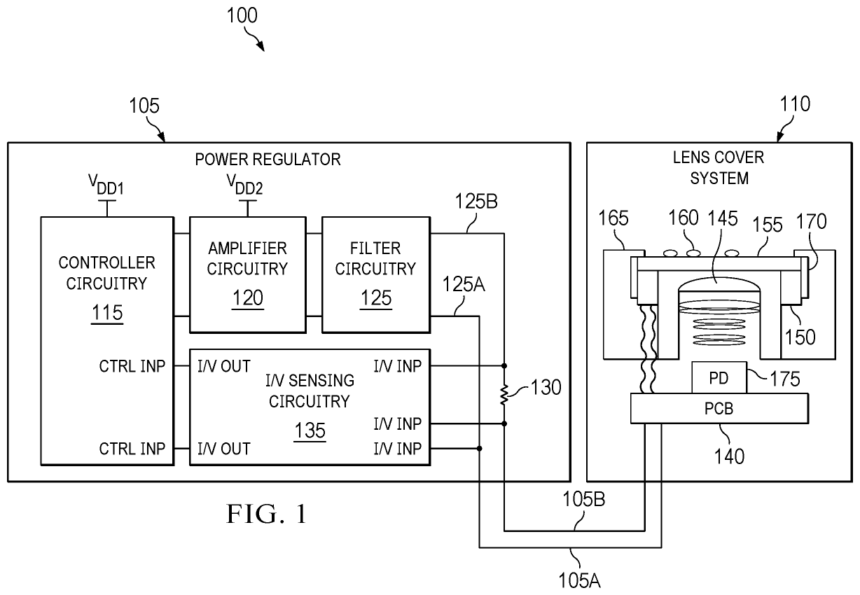

FIG. 1 is a block diagram of an example lens cleaning system 100 including an example power regulator 105 and an example lens cover system 110. The power regulator 105 including a first supply conductor 105A and a second supply conductor 105B configured to supply power to the lens cover system 110. The lens cleaning system 100 is configured to monitor power supplied to the lens cover system 110 using the power regulator 105. The lens cleaning system 100 may modify a frequency and/or amplitude of an excitation signal that is used to generate a signal (e.g., a pulse width modulation (PWM) signal) to supply power to the lens cover system 110. The power regulator 105 may modify the excitation signal to increase the power efficiency, account for variations in impedance of the lens cover system 110, and/or modify power consumed by the lens cover system 110.

In the example of FIG. 1, the power regulator 105 includes controller circuitry 115, amplifier circuitry 120, filter circuitry 125, a resistor 130, and current and voltage (I/V) sensing circuitry 135. The power regulator 105 is coupled to the lens cover system 110 by the first supply conductor 105A and the second supply conductor 105B. The supply conductors 105A and 105B may be referred to as a regulator output. The power regulator 105 monitors power supplied to the lens cover system 110 to increase power efficiency and/or optimize operations of the lens cover system 110.

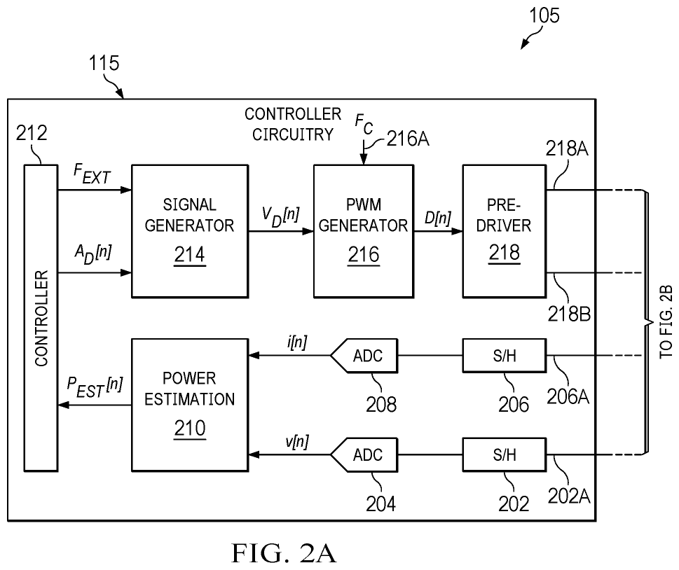

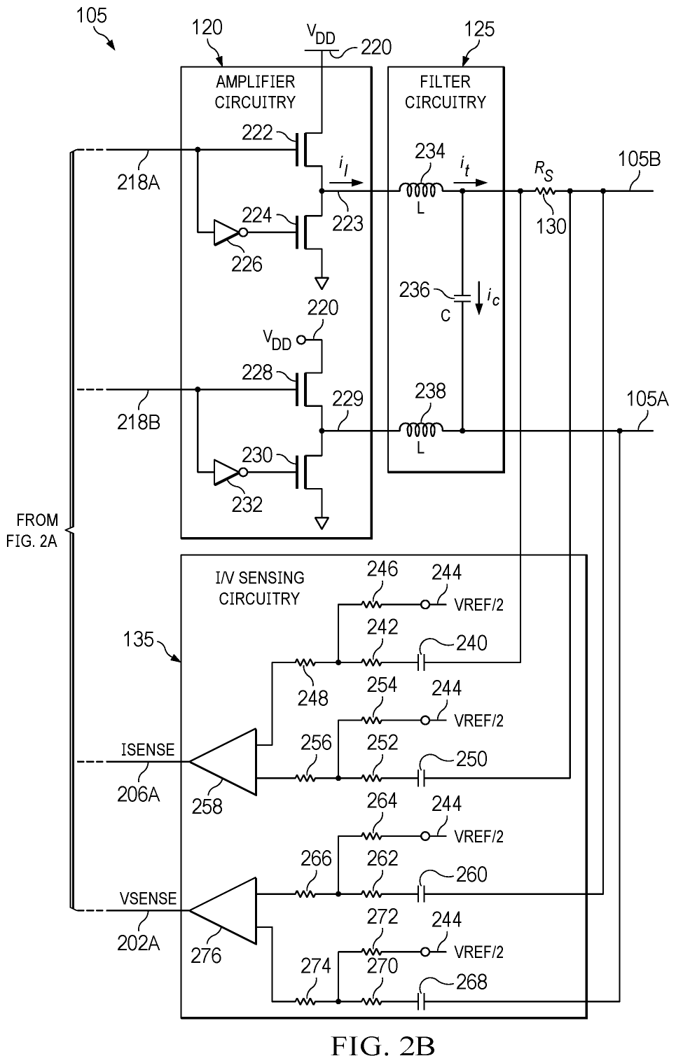

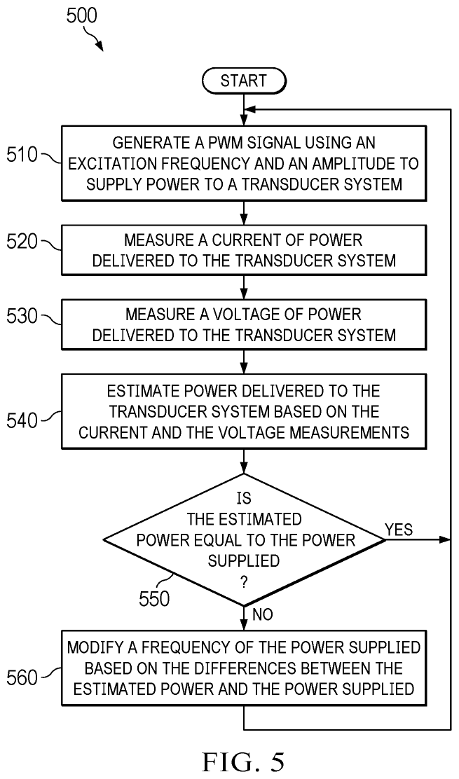

The controller circuitry 115 is coupled to a sensing output of the I/V sensing circuitry 135 and a controller output of the controller circuitry 115 is coupled to an amplifier input of the amplifier circuitry 120. The controller circuitry 115 is configured to generate an PWM signal based on a sinusoidal excitation signal to cause the amplifier circuitry 120 to supply power of a target magnitude to the lens cover system 110. For example, the controller circuitry 115 may use a comparator (not illustrated) coupled to the sinusoidal excitation signal and a triangular waveform to generate a PWM signal. The operation of generating and modifying the PWM signal based on the sinusoidal excitation signal is described in further detail, below, in connection with FIGS. 2A and 5. The sinusoidal excitation signal may be referred to as an excitation signal.

The controller circuitry 115 is configured to estimate the power delivered to the lens cover system 110 using the I/V sensing circuitry 135. The controller circuitry 115 may be configured to increase power efficiency as a result of modifying an excitation frequency to minimize the phase difference between the current and voltage signals supplied to the lens cover system 110 and/or increase a power factor of the power regulator 105. Advantageously, the controller circuitry 115 monitors the power supplied to the lens cover system 110 to maximize power efficiency and ensure a target magnitude of power is supplied to the lens cover system 110. Advantageously, the controller circuitry 115 may modify an amplitude and/or the excitation frequency to increase power efficiency and/or optimize operations of the lens cover system 110.

The amplifier circuitry 120 is coupled between the controller circuitry 115 and the filter circuitry 125, such that the amplifier input is coupled to the controller output and an amplifier output of the amplifier circuitry 120 is coupled to a filter input of the filter circuitry 125. The amplifier circuitry 120 is configured to convert the output of the controller circuitry 115 to an amplified power supply signal. The controller circuitry 115 may be configured to operate in a first power domain and the amplifier circuitry 120 may be configured to operate in the second power domain. Such a differentiation of power domains may decrease a cost of the controller circuitry 115 while the amplifier circuitry 120 may supply power of a higher voltage. For example, the controller circuitry 115 may be configured to generate the PWM signal using a 5 volt (V) power domain, while the amplifier circuitry 120 is configured to generate the amplified PWM signal using a 35 volt (V) power domain. In such an example, a power domain is a potential difference between a supply voltage and a common potential (e.g., ground). Advantageously, the amplifier circuitry 120 may be configured to supply power to the lens cover system 110 using a power domain greater than that of the controller circuitry 115.

The filter circuitry 125 is coupled to the lens cover system 110, the amplifier circuitry 120, the resistor 130, and the I/V sensing circuitry 135. A first output 125A of the filter circuitry 125 is coupled to the first supply conductor 105A and a second output 125B of the filter circuitry 125 is coupled to the second supply conductor 105B by the resistor 130. The filter circuitry 125 is configured as a low pass filter, such that frequencies less than a cut-off frequency are supplied to the lens cover system 110. The filter circuitry 125 may be configured to resist sudden changes in voltages of the output of the amplifier circuitry 120. The filter circuitry 125 may increase the duration of time needed to transition from a logic high to a logic low, such as to smoothen sharp curvatures of the output of the amplifier circuitry 120. For example, the filter circuitry 125 may modify sudden changes from a high potential to a low potential of a square waveform, generated by the amplifier circuitry 120. The filter circuitry 125 may include a voltage divider to generate a potential difference between outputs 125A and 125B of the filter circuitry 125. Alternatively, the filter circuitry 125 may be modified and/or removed from the power regulator 105 based on the amplifier circuitry 120. For example, the amplifier circuitry 120 is a Class D amplifier, which requires the power regulator 105 to include the filter circuitry 125, however if the amplifier circuitry 120 where a linear amplifier, the filter circuitry 125 may not be needed.

The I/V sensing circuitry 135 is coupled to the lens cover system 110, the controller circuitry 115, the filter circuitry 125, and the resistor 130. A sensing input (I/V INP) of the I/V sensing circuitry 135 is coupled to the outputs 125A and 125B of the filter circuitry 125 and a sensing output (I/V OUT) is coupled to a controller input (CTRL INP). The I/V sensing circuitry 135 is coupled across the resistor 130 to measure a current supplied to the lens cover system 110 by dividing a voltage difference across the resistor 130 by a resistance of the resistor 130. Alternatively, another method of measuring the current supplied to the lens cover system 110 may be implemented in accordance with the examples described herein. The I/V sensing circuitry 135 is configured to measure the voltage of the power supplied to the lens cover system 110 by measuring a voltage difference across the supply conductors 105A and 105B. The I/V sensing circuitry 135 may be configured to isolate a power domain of the lens cover system 110 from a power domain of the controller circuitry 115, such that the controller circuitry 115 may sample an output of the I/V sensing circuitry 135 to estimate the power supplied to the lens cover system 110.

In the example of FIG. 1, the lens cover system 110 includes a printed circuit board (PCB) 140, a camera lens 145, a transducer 150, a lens cover 155, contaminants 160, a housing 165, and a seal 170. The transducer 150 may be coupled to the lens cover 155. Alternatively, the transducer 150 may be coupled directly to the camera lens 145, in which case a lens cover 155 is not needed. The lens cover system 110 is configured to be coupled to the power regulator 105 by the supply conductors 105A and 105B, such that the power regulator 105 may supply power to the transducer 150 by driving the supply conductors 105A and 105B. The lens cover system 110 is configured to remove the contaminants 160 as a result of the transducer 150 vibrating the lens cover 155 to provide the camera lens 145 a clear field of view. Advantageously, the lens cover system 110 prevents the contaminants 160 from obstructing the field of view of the camera lens 145.

The PCB 140 is coupled to the power regulator 105 and the transducer 150. The PCB 140 includes a photo diode (PD) 175 capable of converting an optical input to an electrical signal, such that the photo diode 175 may be configured to capture images of the field of view of the camera lens 145. The PCB 140 is configured to couple the transducer 150 to the output of the filter circuitry 125. Alternatively, the transducer 150 may be directly coupled to the output of the filter circuitry 125 or the amplifier circuitry 120 based on the type of amplifier being used. For example, the transducer 150 may be directly coupled to the amplifier circuitry 120 in instances where the amplifier circuitry 120 includes class A, B, or C amplifier circuitry.

The camera lens 145 is coupled to the photo diode 175, such that optical light is supplied by the camera lens 145 to the photo diode 175. The camera lens 145 is configured to increase the field of view of the photo diode 175. The camera lens 145 may include a plurality of lenses to focus and/or modulate light towards the photo diode 175, such that the camera lens 145 and the photo diode 175 comprise a camera system.

The transducer 150 is coupled to the lens cover 155, the housing 165, and the seal 170. Alternatively, the transducer 150 may be coupled directly to the camera lens 145, the housing 165 and the seal 170. The transducer 150 is configured to convert power, supplied by the power regulator 105, to physical vibrations which cause the lens cover 155 and/or the lens 145 to vibrate thereby causing the contaminants 160 to move. The transducer 150 may be a piezoelectric component. The transducer 150 is configured to vibrate the lens cover 155 based on the power supplied by the power regulator 105 to remove the contaminants 160 from the lens cover 155. The impedance of the transducer 150 may vary as the contaminants 160 are removed from and/or as additional contaminants are added to the lens cover 155. For example, the camera cover system 110 implemented in a vehicle may cause the lens cover 155 to be exposed to additional contaminants as the vehicle is in motion. In such an example, the power regulator 105 may modify the power supplied to the camera cover system 110 as the impedance of the transducer 150 varies.

The transducer 150 may be represented as a capacitive load or a resistive load, such that the transducer 150 may be illustrated as a capacitor or a resistor in a circuit diagram. A phase difference between a current and a voltage being supplied to the transducer 150 may be determined by the power regulator 105 sampling a current and a voltage measurement determined by the IN sensing circuitry 135. Minimizing the phase difference between the current and the voltage being supplied to the transducer 150 decreases reactive power and increases real power. The reactive power supplied to the transducer 150 is power not converted into physical vibrations and is wasted, typically by recirculating through the system and generating heat. The real power supplied to the transducer 150 causes physical vibrations, which are used to clean the lens cover system 110. The power regulator 105 may include circuitry to estimate a phase difference between the current and the voltage supplied to the lens cover system 110 to determine whether power is being wasted as reactive power. For example, the power regulator 105 may be configured to adjust the power supplied to an example capacitive load (not illustrated) to modify an estimated phase angle to be approximately seventy degrees, such that a magnitude of reactive power is minimized, and a magnitude of real power is maximized. The power regulator 105 may modify the power supplied to a resistance to modify the estimated angle to be approximately (preferably exactly) zero to minimize a magnitude of reactive power and maximize a magnitude of real power. Advantageously, the power regulator 105 may determine the transducer 150 is representative of a capacitive or resistive load, such as to minimize the estimated phase angle to zero degrees or seventy degrees.

The housing 165 is coupled to the seal 170. The housing 165 is configured to house the transducer 150 and the lens cover 155, such that the PCB 140, the camera lens 145, and the photo diode 175 are protected from exposure to the contaminants 160. The seal 170 is coupled between the housing 165 and transducer 150 and between the housing 165 and the lens cover 155, such that the contaminants 160 are prevented from reaching lens 145 and/or the photo diode 175.

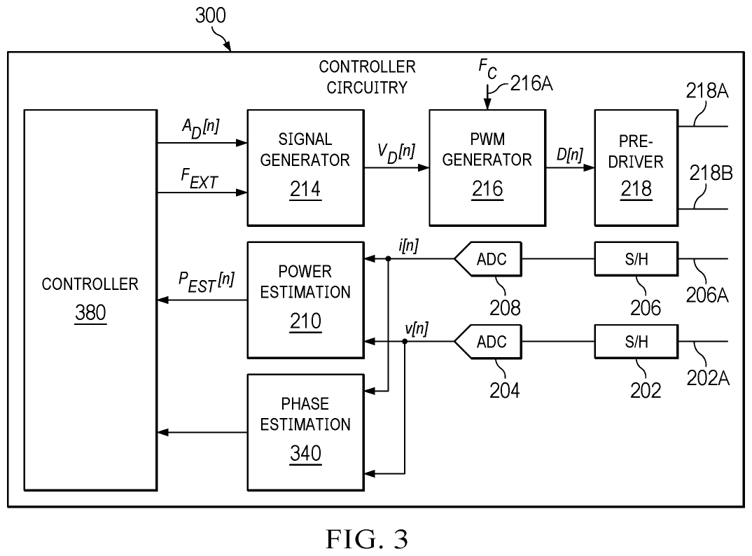

In example operation, the controller circuitry 115 generates an excitation signal of an amplitude and an excitation frequency in a first power domain. The controller circuitry 115 generates a PWM signal using the excitation signal. The amplitude of the excitation signal is determined based on a target magnitude of power to be supplied to the transducer 150. The target magnitude of power may be determined based on characteristics of the lens cleaning system 110. Such characteristics of the transducer 150 correspond to conditions that may require an increase or decrease in power. The impedance of the transducer 150 varies as operating conditions (e.g., temperature, stress, etc.) vary. For example, the controller circuitry 115 may be configured to approximate an impedance of the transducer 150 to determine the target magnitude. In such an example, the controller circuitry 115 may select corresponding calibrated characteristics of the power regulator 105 based on the approximated impedance of the transducer 150. The controller circuitry 115 may approximate an impedance of the transducer 150 by comparing an estimate of real power supplied to the transducer 150 to the target magnitude. The target magnitude may be a value stored in memory and/or determined as a result a calibration process. Alternatively, the controller circuitry 115 may determine the impedance of the transducer 150 in order to determine a target magnitude. The controller circuitry 115 may use phase estimation circuitry (illustrated in FIG. 3, below) to determine values of real power and reactive power being supplied to the transducer 150 based on an estimated phase angle between a current and a voltage measurement. The impedance of the transducer 150 may be used to determine a magnitude of the reactive power based on an estimation of power being supplied. Advantageously, the controller circuitry 115 may determine the target magnitude of power to be supplied based on characteristics of the transducer 150, which modify the impedance.

The first power domain (V_{DD1}) corresponds to a supply voltage of the controller circuitry 115. The amplifier circuitry 120 is configured to convert the PWM signal, generated by the controller circuitry 115, into an amplified PWM signal in a second power domain (V_{DD2}). The second power domain corresponds to a supply voltage of the amplifier circuitry 120. The amplified PWM signal is provided to the lens cover system 110 with a varying duty cycle, such as to reduce audible noise generated by the vibrations of the transducer 150. The filter circuitry 125 is configured to decrease the components of the amplified PWM signal having frequencies greater than a cut-off frequency, such that jitter and noise on the amplified PWM signal are reduced.

The filtered amplified PWM signal excites the transducer 150 to vibrate and remove the contaminants 160 from the lens cover 155. The transducer 150 vibrations to cause the photo diode 175 (which may include an array of photo diodes and/or other equivalent apparatus for capturing an image) to convert an unobstructed optical input into a digital value representative of an image of the field of view. The inductance of the transducer 150 may vary as the contaminants 160 are vibrated off of the lens cover 155 and/or as additional contaminants are added to the lens cover 155.

In example operation, the impedance of the transducer 150 modifies the filtered amplified PWM signal as a result of a shift in the frequency response caused by the impedance and/or the excitation frequency. The variations in the filtered amplified PWM signal are determined by measuring the voltage and the current using the I/V sensing circuitry 135. The I/V sensing circuitry 135 utilizes the voltage difference across the resistor 130 and supplies it to the controller circuitry 115, such that the controller circuitry 115 may determine the current being supplied to the lens cover system 110. Additionally, the I/V sensing circuitry 135 scales the measured potential differences from the power domain of the filtered amplified PWM signal to a scaled measurement capable of being represented by the power domain of the controller circuitry 115. Advantageously, the I/V sensing circuitry 135 may measure potential differences across a power domain greater than the respective power domain of the controller circuitry 115 by scaling measurements to values which may be represented in the respective power domain of the controller circuitry.

The controller circuitry 115 estimates the power supplied to the lens cover system 110, and/or may estimate a phase angle difference between the current and the voltage supplied to the lens cover system 110 using the current and voltage measurements supplied by the I/V sensing circuitry 135. The controller circuitry 115 determines a power factor and/or efficiency of the power regulator 105 as a result of comparing the estimate of power delivered to the lens cover system 110 and the target magnitude of power to be supplied as a result of the excitation signal. The target magnitude of power to be supplied is a value representative of a condition of power transfer corresponding to approximately no power being wasted as reactive power. As the impedance of the transducer 150 varies, the target magnitude of power to be supplied may vary as the variations in the impedance change the frequency response. For example, power supplied to the transducer 150 may shift to increase reactive power and decrease real power magnitudes as the impedance varies. In such an example, variations in real power and reactive power in response to variations in impedance may be determined by estimating the phase angle between a current and a voltage measurement. The controller circuitry 115 may modify the amplitude and/or excitation frequency to modify the magnitude of power delivered to the lens cover system 110 and/or increase the power factor (whereby a power factor equal to one is representative of one-hundred percent of the power being supplied by the power regulator being real power). In some examples, the power factor approaches (and may be equal to) one.

FIGS. 2A and 2B are a schematic diagrams of the power regulator 105 of FIG. 1 including the controller circuitry 115 of FIG. 1 configured to estimate power consumed by lens cover system 110 of FIG. 1. In the examples of FIGS. 2A and 2B, the power regulator 105 includes the controller circuitry 115, the amplifier circuitry 120, the filter circuitry 125, the resistor 130, and the IN sensing circuitry 135. The power regulator 105 may be coupled to the lens cover system 110 of FIG. 1 or another transducer system.

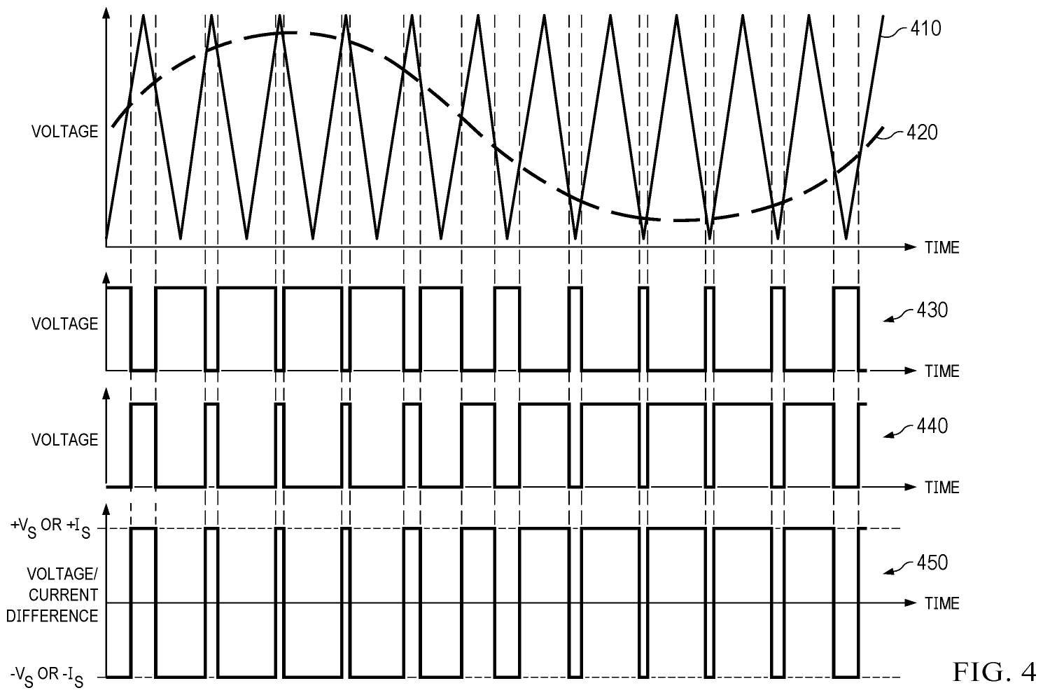

In the example of FIG. 2A, the controller circuitry 115 includes a first sample and hold (S/H) circuitry 202, a first analog to digital converter (ADC) 204, a second S/H circuitry 206, a second ADC 208, power estimation circuitry 210, a controller 212, a signal generator 214, a PWM generator 216, and pre-driver circuitry 218. The controller circuitry 115 may be implemented using analog circuitry, a processor, digital circuitry, a state machine, memory, analog circuitry, software and/or any combination thereof. The controller circuitry 115 is coupled to the amplifier circuitry 120 across a first pre-driver conductor 218A and a second pre-driver conductor 218B. The controller circuitry 115 is configured to generate a PWM output based on a carrier frequency and an excitation signal of an amplitude and an excitation frequency. The controller circuitry 115 generates a sinusoidal signal of the amplitude and the excitation frequency, such a sinusoidal signal may be referred to as an excitation signal. The excitation signal is used to generate the PWM output. The PWM output includes a varying duty cycle as a result of comparing the excitation signal to a carrier signal of a carrier frequency. The carrier frequency is greater than the excitation frequency to ensure the sinusoidal wave form varies a duty cycle of the PWM output. The carrier signal may be a triangular waveform to increase linearity of the PWM output and to reduce harmonics of the PWM output. The excitation signal, the carrier signal, and the PWM output are described in connection with FIG. 4, below.

The PWM output is configured to cause the amplifier circuitry 120 to supply power of a target magnitude to a transducer (e.g., the transducer 150 of FIG. 1). The PWM output determines a magnitude of power to be supplied to the supply conductors 105A and 105B. The controller circuitry 115 is configured to estimate the power delivered to transducer circuitry coupled to the supply conductors 105A and 105B based on voltages and/or currents at a first measurement conductor 202A and/or a second measurement conductor 206A. The measurement conductors 202A and 202B are coupled to the I/V sensing circuitry 135. The controller circuitry 115 is configured to modify the amplitude and/or excitation frequency of the PWM signal based on an estimated power delivered. The estimated power delivered is a value, representative of a magnitude of power supplied across the supply conductors 105A and 105B. The estimated power delivered is determined by the controller circuitry 115 using a current and a voltage measurement supplied by the I/V sensing circuitry 135.

The first S/H circuitry 202 is coupled between the I/V sensing circuitry 135 and the first ADC 204. The S/H circuitry 202 is configured to sample a voltage at the first measurement conductor 202A. The voltage of the first measurement conductor 202A may be sampled at a fixed duration. The first S/H circuitry 202 is configured to provide the voltage at the first measurement conductor 202A to an analog input of the first ADC 204 for the duration between sampling of the first measurement conductor 202A. The duration between sampling of the first measurement conductor 202A may be determined based on a duration required by the first ADC 204 to determine a digital representation of the voltage measurement of the analog input. Advantageously, the first S/H circuitry 202 sets the analog input of the first ADC 204 to a fixed voltage for a duration which enables the first ADC 204 to determine a digital representation of the voltage of the first measurement conductor 202A at the moment in time that the S/H circuitry 202 sampled the first measurement conductor 202A.

The first ADC 204 is coupled between the first S/H circuitry 202 and the power estimation circuitry 210. The first ADC 204 is configured to convert an analog voltage input, supplied by the first S/H circuitry 202, to a digital output. Such an analog voltage may be represented by a plurality of bits as a digital value. The first ADC 204 is configured to convert the analog voltage input to the digital output in a duration of time less than or equal to the duration between samples of the first measurement conductor 202A. In the example of FIG. 2A, the digital output of the first ADC 204 is a digital and discrete representation of the voltage supplied to the supply conductors 105A and 105B. The discrete representation of the voltage (v[n]) is a sampled representation of a continuous time signal, such that the continuous time signal is the voltage delivered to the supply conductors 105A and 105B.

The second S/H circuitry 206 is coupled between the I/V sensing circuitry 135 and the second ADC 208, such that the second measurement conductor 206A is coupled to an input of the S/H circuitry 206 and an output of the I/V sensing circuitry 135. The second S/H circuitry 206 may be configured similar to the first S/H circuitry 202. The second S/H circuitry 206 is configured to sample the voltage and/or current at the second measurement conductor 206A and hold this value for a fixed duration. The duration between sampling of the second measurement conductor 206A is determined based on a duration of time required by the second ADC 208 to convert the output of the second S/H circuitry 206 to a digital representation of the voltage measurement of the analog input. The duration between sampling of the S/H circuitry 206 and 202 may be configured to be approximately equal, such that circuitry to initiate the sample may be used for both of the S/H circuitry 202 and 206 to decrease cost, SoC package size, and/or integration complexity.

The second ADC 208 is coupled between the second S/H circuitry 206 and the power estimation circuitry 210. The second ADC 208 is configured to convert an analog voltage input from the second S/H circuitry 206 to a digital output representative of a voltage difference across the resistor 130. The digital output of the second ADC 208 is a digital and discrete representation of a potential difference, which may be used to determine the current supplied to the second supply conductor 105B. For example, the controller circuitry 115 may determine the current supplied to the second supply conductor 105B as a result of dividing the potential difference represented by the digital output of the second ADC 208 by a resistance of the resistor 130. The digital output of the second ADC 208 (i[n]) is a sampled representation of the continuous time voltage signal across the resistor 130. The second ADC 208 may be configured similar to the first ADC 204.

The power estimation circuitry 210 is coupled to the first ADC 204, the second ADC 208, and the controller 212. The power estimation circuitry 210 is configured to estimate the power delivered to the supply conductors 105A and 105B based on the discrete and digital outputs of the ADCs 204 and 208. The power estimation circuitry 210 may estimate the power delivered to the supply conductors 105A and 105B as a result of multiplying the output of the first ADC 204, representing a voltage, by the output of the second ADC 208 divided by the resistance of the resistor 130, representing the current supplied to the second supply conductor 105B. The power estimation circuitry 210 determines an estimate of the power delivered (P_{EST}[n]) to the supply conductors 105A and 105B as a digital and discrete value, such that the estimate of the power delivered may be supplied to controller 212 for digital processing.

The controller 212 is coupled between the power estimation circuitry 210 and the signal generator 214. The controller 212 is configured to determine an amplitude (A_{d}[n]) and an excitation frequency (F_{EXT}) of the PWM signal, generated on the pre-driver conductors 218A and 218B, based on the estimate of power being supplied (P_{EST}[n]), a desired power level to be supplied (P_{d}[n]), and an amplitude of the voltage being supplied (A[n]). The desired power level to be supplied represents the target magnitude of power to be supplied to the supply conductors 105A and 105B as a result of supplying an excitation signal using the amplitude of the power to be supplied. The amplitude of the power to be supplied is an amplitude of the PWM signal supplied to the amplifier circuitry 120 which is used to determine, by the power estimation circuitry 210, an estimate of the power being supplied.

The controller 212 may be configured to determine the amplitude based on a method of amplitude control and/or proportional, integral, derivative (PID) control. The amplitude control is configured to determine the amplitude of the excitation signal as a result of scaling, by a scaler value (k[n]), the amplitude of the power being supplied. The scaler value is a value representing a ratio of a desired power to be supplied over the estimate, determined by the power estimation circuitry 210, of the power being supplied. In an example of amplitude control, the amplitude of the excitation signal may be represented by Equations (1) and (2), below. Equation (1), below, is useful to determine the scaler value, and equation (2), below, is useful to determine the amplitude of the excitation signal to be generated as a result of the square root of the scaler value times the amplitude of power being supplied. Additionally, the controller 212 is configured to limit power supplied to the lens cover system 110 to be no greater than a maximum power, such that the power supplied is prevented from causing the transducer 150 to harm the lens cover system 110. The controller 212 may reduce the amplitude of the excitation signal as a result of determining the power supplied approaching the maximum power value.

$$k [ n ] = \frac{{P}_{d} [ n ]}{{P}_{EST} [ n ]} , \qquad Equation ( 1 )$$

$${A}_{d} [ n ] = \sqrt{k [ n ]} * A [ n ] , \qquad Equation ( 2 )$$

The controller 212 may be configured to determine the amplitude of the excitation signal, to be generated, based on PID control. PID control determines the amplitude of the excitation signal based on the estimate of power being supplied (P_{EST}[n]), the desired power to be supplied (P_{d}[n]), an error value (e[n]), a first coefficient (Kₚ) a second coefficient (Kᵢ), and a third coefficient (K_{d}). The error value is a value representative of the difference between the desired power to be supplied and the estimate of power being supplied. The first coefficient is a non-negative coefficient representative of a proportional contribution to the amplitude being determined. The second coefficient is a non-negative coefficient representative of an integral contribution to the amplitude being determined. The third coefficient is a non-negative coefficient representative of a derivative contribution to the amplitude being determined. The first, second, and third coefficients may be calibrated, set, and/or determined during the process of manufacturing, device testing, system testing and/or in real-time as a part of a training phase of operation. The training phase corresponding to a duration of time that the power regulator 105 is being calibrated to increase accuracy, such that the first, second, and third coefficients are determined based on previous operations of the power regulator 105. PID control that is configured to determine the amplitude of the excitation signal may be implemented using Equation (3) and (4), below. Equation (3), below, determines the error value, and Equation (4), below, determines the amplitude of the excitation signal.

$$e [ n ] = {P}_{d} [ n ] - {P}_{EST} [ n ] , \qquad Equation 3$$

$${A}_{d} [ n ] = {K}_{p} \cdot e [ n ] + {K}_{i} \cdot \int e [ n ] + {K}_{d} \cdot \frac{d}{dt} e [ n ] , \qquad Equation 4$$

The controller 212 may be configured to determine the excitation frequency as a result of performing a frequency sweep and determining the frequency with the highest power factor. A power factor is a value representing the power supplied (to conductors 105A and 105B) over the desired power, such that wasting power decreases the power factor. For example, a power factor equal to one corresponds to one-hundred percent of power being supplied to the lens cover system 110 being real power. In the example of FIGS. 2A and 2B, the frequency sweep includes the controller 212 setting the excitation frequency of the excitation signal to a first frequency and determining a first power factor corresponding to the first frequency. In response to determining the first power factor, the controller 212 sets the excitation frequency to a second frequency and determines a second power factor. The controller 212 may set the excitation frequency a plurality of times to determine a plurality of power factors across an operational frequency range of the excitation frequency. For example, the controller 212 may determine a power factor for possible frequencies, which are an incremental value apart, starting a frequency sweep at a minimum frequency and incrementing the excitation frequency until a power factor is determined for the maximum frequency. The controller 212 compares the power factors, determined during the frequency sweep, to select an excitation frequency for the excitation signal which maximizes the efficiency of the power regulator 105. For example, the controller 212 selects the excitation frequency wherein the power factor is closest to one, such that the efficiency is maximized. Advantageously, the controller 212 may select an excitation frequency of the PWM signal based on the frequency response of the power supplied to a transducer. Advantageously, the controller 212 may modify the power supplied to the supply conductors 105A and 105B based on the impedance of the transducer 150, such that the power regulator 105 optimizes power efficiency as the contaminants 160 are removed or added.

The signal generator 214 is coupled between the controller 212 and the PWM generator 216. The signal generator 214 may be implemented digitally or by using analog circuitry. In an example digital implementation, the signal generator 214 is configured to generate a discrete representation of the excitation signal (V_{D}[n]), discussed above and below in FIG. 4, based on the amplitude (A_{D}[n]) and an excitation frequency (F_{EXT}) determined by the controller 212. The discrete representation of the excitation signal is a discrete signal, which enables the signal generator 214 to be implemented digitally using processor circuitry (e.g., a microcontroller, processor circuitry, field programable gate array (FPGA), etc.). The discrete signal, generated by the signal generator 214, is a plurality of values representative of the excitation signal, a continuous time sinusoidal signal, which may be used by the controller circuitry 115 to generate the PWM output across the pre-driver conductors 218A and 218B digitally. For example, the signal generator 214 may generate a discrete excitation signal based on the amplitude and the excitation frequency determined by the controller 212 to reduce the cost and the integration complexity of implementing sinusoidal waveform generation. In an example analog implementation, the signal generator 214 includes circuitry (e.g., a waveform generator) to generate excitation signal as a sinusoidal signal of the amplitude and excitation frequency determined by the controller 212.

The PWM generator 216 is coupled between the signal generator 214 and the pre-driver circuitry 218. The PWM generator 216 is configured to generate a PWM output (D[n]) of a varying duty cycle based on the excitation signal (V_{D}[n]) and a carrier signal (F_{C}) from a carrier frequency input 216A. The PWM generator 216 may generate the PWM output as a result of comparing the excitation signal to the carrier signal. For example, the PWM generator 216 may set the PWM output to a logic high during durations where an amplitude of the carrier signal is greater than an amplitude of the excitation signal and a logic low during durations where the amplitude of the carrier signal is less than the amplitude of the excitation signal. Such an example is illustrated in FIG. 4, below. The PWM generator 216 may be implemented digitally or by using analog circuitry. In an example digital implementation, the PWM generator 216 may compare samples of the discrete excitation signal to the carrier signal analog to generate a PWM signal. In an example analog implementation, the PWM generator 216 may use analog circuitry to compare the continuous time excitation signal to the carrier signal to generate a PWM signal. For example, the PWM generator 216 may include a comparator configured to compare the excitation signal to the carrier signal, such that the comparator output is a logic high during durations where an amplitude of the carrier signal is greater than an amplitude of the excitation signal and a logic low during durations where the amplitude of the carrier signal is less than the amplitude of the excitation signal. Additionally, the PWM generator 216 may be configured to convert the output of the signal generator 214 from complementary metal oxide (CMOS) logic to current mode logic (CML) to increase the efficiency of power transmission from the power regulator 105 to the lens cover system 110. The PWM signal generated by the PWM generator 216 is illustrated in FIG. 4, below.

The pre-driver circuitry 218 is coupled between the PWM generator 216 and the amplifier circuitry. The outputs of the pre-driver circuitry 218 are connected to the pre-driver conductors 218A and 218B. The pre-driver circuitry 218 converts the PWM signal of the PWM generator 216 to a first PWM signal and a second PWM signal, such that the first PWM signal is an inverse of the second PWM signal. The pre-driver circuitry 218 outputs the first PWM signal to the first pre-driver conductor 218A and the second PWM signal to the second pre-driver conductor 218B. The pre-driver circuitry 218 may be implemented digitally or by using analog circuitry. In an example digital implementation, the pre-driver circuitry 218 may be implemented by setting two general-purpose input/output (GPIO) pins corresponding to the pre-driver conductors 218A and 218B, such that the first PWM signal is approximately equal to the PWM signal generated by the PWM generator 216 and the second PWM signal is an inverted version of the PWM signal generated by the PWM generator 216. In an example analog implementation, the pre-driver circuitry 218 includes circuitry to invert the PWM signal generated by the PWM generator 216, such that the first PWM signal is approximately equal to the PWM signal generated by the PWM generator 216 and the second PWM signal is an inverted version of the PWM signal generated by the PWM generator 216. For example, the pre-driver circuitry 218 may include an inverter to invert the PWM signal generated by the PWM generator 216 and circuitry to delay the PWM signal generated by the PWM generator 216 to compensate for gate delay of the inverter. The pre-driver circuitry 218 may be configured to include circuitry to convert the PWM signal from CMOS logic to CML to decrease power loss during transmission.

In the example of FIG. 2B, the amplifier circuitry 120 includes a supply voltage 220, a first transistor 222, a first driver conductor 223, a second transistor 224, a first inverter 226, a third transistor 228, a second driver conductor 229, a fourth transistor 230, and a second inverter 232. The amplifier circuitry 120 is coupled between the controller circuitry 115 and the filter circuitry 125, such that the amplifier circuitry 120 is coupled to the pre-driver conductors 218A and 218B. Since the controller circuitry 115 may operate using a supply voltage that is different (e.g., a lower supply voltage, such as around 1.8 to 5 volts) than the supply voltage used to drive the lens cover system, the amplifier circuitry 120 (which may use a supply voltage that is between 10 to 48 volts or between 15 and 35 volts) is configured to convert the PWM signal from the pre-driver conductors 218A and 218B of a first power domain to a PWM signal of a second power domain (where the first power domain is the power domain of the controller circuitry 115 and the second power domain is a power domain of the circuitry coupled to the supply conductors 105A and 105B). The amplifier circuitry 120 is configured to drive the driver conductors 223 and 229 to the supply voltage 220 or a common potential (e.g., ground) based on the PWM signal on the pre-driver conductors 218A and 218B. The amplifier circuitry 120 may include a class D driver, such that the amplifier circuitry 120 may function as a switching amplifier. Alternatively, the amplifier circuitry 120 may include linear amplifier circuitry (e.g., class A, class B, class AB, class C, etc.) configured to generate an output signal based on a continuous input waveform. The amplifier circuitry 120 may also include gate driver circuitry and/or fault protection circuitry.

The first transistor 222 is coupled between the supply voltage 220 and the second transistor 224, such that the first driver conductor 223 is coupled between the transistors 222 and 224. The first transistor 222 is coupled to the first pre-driver conductor 218A, such that the first transistor 222 may be turned on (e.g., conducting) or turned off (e.g., non-conducting) by the PWM signal generated by the controller circuitry 115. The first transistor 222 is configured to couple the first driver conductor 223 to the supply voltage 220 as a result of the first pre-driver conductor 218A enabling the first transistor 222, such that a voltage of the first pre-driver conductor 218A is greater than a threshold voltage of the first transistor 222.

The second transistor 224 is coupled between common potential (e.g., ground potential) and the first transistor 222. The second transistor 224 is coupled to the first inverter 226, such that an output of the first inverter 226 may enable and/or disable the second transistor 224. The second transistor 224 is configured to couple the first driver conductor 223 to common potential as a result of the first inverter 226 enabling the second transistor 224, such that a voltage of an output of the inverter 226 is greater than a threshold voltage of the second transistor 224.

The first inverter 226 is coupled between the first pre-driver conductor 218A and the second transistor 224, such that the output of the first inverter 226 may enable or disable the second transistor 224. The first inverter 226 is configured to enable the second transistor 224 during durations of the PWM signal that disable the first transistor 222, such that the second transistor 224 is in an opposite mode of operation (e.g., turned on or turned off) compared to the first transistor 222. The inverter 226 enables, the first driver conductor 223 to be coupled to common potential during the durations when the PWM signal is at a lower voltage level (e.g., a logic low) and coupled to the supply voltage 220 during the durations when the PWM signal is at a higher voltage level (e.g., a logic high).

The third transistor 228 is coupled between the supply voltage 220 and the fourth transistor 230, such that the second driver conductor 229 is coupled between the transistors 228 and 230. The third transistor 228 is coupled to the second pre-driver conductor 218B, such that the third transistor 228 may be turned on or turned off by the PWM signal generated by the controller circuitry 115. The third transistor 228 is configured to couple the second driver conductor 229 to the supply voltage 220 as a result of the second pre-driver conductor 218B enabling the third transistor 228, such that a voltage of the second pre-driver conductor 218B is greater than a threshold voltage of the third transistor 228.

The fourth transistor 230 is coupled between common potential and the third transistor 228. The fourth transistor 230 is coupled to the second inverter 232, such that an output of the second inverter 232 may enable and/or disable the fourth transistor 230. The fourth transistor 230 is configured to couple the second driver conductor 229 to common potential as a result of the second inverter 232 enabling the fourth transistor 230, such that a voltage of an output of the inverter 226 is greater than a threshold voltage of the fourth transistor 230.

The second inverter 232 is coupled between the second pre-driver conductor 218B and the fourth transistor 230, such that the output of the second inverter 232 may enable or disable the fourth transistor 230. The second inverter 232 is configured to enable the fourth transistor 230 during durations of the PWM signal that disable the third transistor 228, such that the fourth transistor 230 is in an opposite mode of operation (e.g., turned on or turned off) compared to the third transistor 228. The inverter 226 enables, the second driver conductor 229 to be coupled to common potential during the durations when the PWM signal is a logic low and coupled to the supply voltage 220 during the durations when the PWM signal is a logic high.

In the example of FIG. 2B, the filter circuitry 125 includes a first inductor 234, a first capacitor 236, and a second inductor 238. The filter circuitry 125 is coupled to the supply conductors 105A and 105B, the amplifier circuitry 120, the resistor 130, and the I/V sensing circuitry 135. The filter circuitry 125 is configured as a low pass filter, such that magnitudes of the portions of signals with frequencies greater than a cut-off frequency are attenuated.

The first inductor 234 is coupled between the first driver conductor 223 and the resistor 130. The first capacitor 236 is coupled between the first inductor 234 and the second inductor 238, such that one conductor is coupled to the resistor 130 and the first inductor 234. The second inductor 238 is coupled between the I/V sensing circuitry 135 and the second driver conductor 229, such that one conductor is coupled to both the I/V sensing circuitry 135 and the first capacitor 236. The first inductor 234 and the first capacitor 236 are configured as a low pass filter for the first driver conductor 223. The first capacitor 236 and the second inductor 238 are configured as a low pass filter for the second driver conductor 229. Advantageously, the cut-off frequency of the low pass filters may be modified as a result of changing the inductance and/or capacitance of the inductors 234 and 238 and/or the first capacitor 236.

In the example of FIG. 2B, the I/V sensing circuitry 135 includes a second capacitor 240, a second resistor 242, a second reference voltage 244, a third resistor 246, a fourth resistor 248, a third capacitor 250, a fifth resistor 252, a sixth resistor 254, a seventh resistor 256, a first amplifier 258, a fourth capacitor 260, an eighth resistor 262, a ninth resistor 264, a tenth resistor 266, a fifth capacitor 268, a eleventh resistor 270, a twelfth resistor 272, a thirteenth resistor 274, and a second amplifier 276. The I/V sensing circuitry 135 is configured to measure the voltage difference across the supply conductors 105A and 105B and across the first resistor 130, such that the controller circuitry 115 may estimate the power supplied to the supply conductors 105A and 105B. The I/V sensing circuitry 135 is configured to convert the voltage differences from a power domain of circuitry coupled to the supply conductors 105A and 105B (e.g., from a voltage level around 15 to 35 volts) to the power domain of the controller circuitry 115 (e.g., to a voltage level around 1.8 to 5 volts), such that the controller circuitry 115 may determine a value representing the voltage differences supplied by the I/V sensing circuitry 135. The I/V sensing circuitry 135 converts the differential potential difference to a single ended potential, such that the voltage differences are represented with respect to the common potential.

The second capacitor 240 is coupled between the filter circuitry 125 and the second resistor 242. The second resistor 242 is coupled between the second capacitor 240 and the fourth resistor 248. The second capacitor 240 is a direct current (DC) blocking capacitor, such that DC offset and/or low frequency noise is removed from the current and/or the voltage measurement. The third resistor 246 is coupled between the second reference voltage 244 and the fourth resistor 248, such that the resistors 242, 246, and 248 are coupled. The fourth resistor 248 is coupled between the third resistor 246 and the first amplifier 258. The resistors 242, 246, and 248 are configured as a voltage divider, such that a voltage of a power domain greater than the second reference voltage 244 is reduced.

The third capacitor 250 is coupled between the first supply conductor 105A and the fifth resistor 252. The fifth resistor 252 is coupled between the third capacitor 250 and the seventh resistor 256. The third capacitor 250 is a DC blocking capacitor, such that DC offset and/or low frequency noise is removed from the current and/or the voltage measurement. The sixth resistor 254 is coupled between the second reference voltage 244 and the seventh resistor 256, such that the resistors 252, 254, and 256 are coupled. The seventh resistor 256 is coupled between the sixth resistor 254 and the first amplifier 258. The resistors 252, 254, and 256 are configured as a voltage divider. The first amplifier 258 is coupled to the second measurement conductor 206A of the controller circuitry 115. The first amplifier 258 is configured to convert the differential input from the resistors 248 and 256 to a voltage in reference to common potential. The first amplifier 258 may be a differential amplifier with a gain equal to one or lower, such that a voltage difference across the first resistor 130 that is greater than the power domain of the controller circuitry 115 may be accurately determined without trimming.

The fourth capacitor 260 is coupled between the second supply conductor 105B and the eighth resistor 262. The eighth resistor 262 is coupled between the fourth capacitor 260 and the tenth resistor 266. The fourth capacitor 260 is a DC blocking capacitor, such that DC offset and/or low frequency noise is removed from the current and/or the voltage measurement. The ninth resistor 264 is coupled between the second reference voltage 244 and the tenth resistor 266, such that the resistors 262, 264, and 266 are coupled. The tenth resistor 266 is coupled between the ninth resistor 264 and the second amplifier 276. The resistors 262, 264, and 266 are configured as a voltage divider.

The fifth capacitor 268 is coupled between the first supply conductor 105A and the eleventh resistor 270. The eleventh resistor 270 is coupled between the fifth capacitor 268 and the thirteenth resistor 274. The fifth capacitor 268 is a DC blocking capacitor, such that DC offset and/or low frequency noise is removed from the current and/or the voltage measurement. The twelfth resistor 272 is coupled between the second reference voltage 244 and the thirteenth resistor 274, such that the resistors 270, 272, and 274 are coupled. The thirteenth resistor 274 is coupled between the twelfth resistor 272 and the second amplifier 276. The resistors 270, 272, and 274 are configured as a voltage divider. The second amplifier 276 is coupled to the second measurement conductor 206B of the controller circuitry 115. The second amplifier 276 is configured to convert the differential input from the resistors 266 and 274 to a voltage in reference to common potential. The second amplifier 276 may be a differential amplifier with a gain equal to one or lower, such that a voltage difference across the supply conductors 105A and 105B that is greater than the power domain of the controller circuitry 115 may be accurately determined without trimming.

In example operation, the controller 212 sets an amplitude and an excitation frequency based on a comparison of the power generated by the power regulator and the power supplied to the supply conductors 105A and 105B. The controller 212 may determine the excitation frequency as a result of determining a frequency with the greatest power factor. The controller 212 may determine the amplitude based on an amplitude control, using Equations (1) and (2), above, or PID control using Equations (3) and (4), above. The signal generator 214 generates a discrete representation of a PWM signal of the amplitude and the excitation frequency indicated by the controller 212. The PWM generator 216 encodes the discrete representation of the PWM signal onto a carrier frequency. The PWM circuitry generates a continuous time PWM signal based on the encoded discrete representation of the PWM signal.

The amplifier circuitry 120 is configured to convert the PWM signal generated across the pre-driver conductors 218A and 218B from a first power domain of the controller circuitry 115 to a second power domain of circuitry coupled to the supply conductors 105A and 105B. The filter circuitry 125 is configured to filter out frequencies greater than the cut-off frequency of inductor-capacitor low pass filters coupled to the output of the amplifier circuitry 120.

The I/V sensing circuitry 135 measures the potential difference across the first resistor 130 and across the supply conductors 105A and 105B. The I/V sensing circuitry 135 steps down the voltage of the measured potential differences to a voltage that may be represented in the power domain of the controller circuitry 115. The S/H circuitry 202 and 206 sample the measured potential differences generated by the I/V sensing circuitry 135 and holds the sampled potential to enable the ADCs 204 and 208 to convert the analog potentials into digital outputs. The power estimation circuitry 210 determines the power supplied to the supply conductors 105A and 105B based on the digital outputs of the ADCs 204 and 208. The controller circuitry 115 may modify the amplitude of the PWM signal based on the estimated power supplied. The controller circuitry 115 may continue to estimate power supplied to the supply conductors 105A and 105B ensure the power regulator 105 operations are power efficient.

Advantageously, the power regulator 105 may modify the power supplied to the supply conductors 105A and 105B based on the efficiency of power transfer. Advantageously, the power regulator 105 may modify the power supplied to the supply conductors in response to a decrease in efficiency caused by a variation in impedance of the transducer 150. Advantageously, the power regulator 105 may increase power supplied to the transducer 150 to supply power of a magnitude approximately (preferably exactly) equal to the target magnitude of power.

FIG. 3 is a schematic diagram of a second example controller circuitry 300 configured to estimate power supplied and estimate a phase difference between the voltage applied across transducer 150 and the current supplied to transducer 150. In the example of FIG. 3, the second controller circuitry 300 includes the features illustrated in FIG. 2A for controller circuitry 115 in addition to phase estimation circuitry 340 and controller 380 (which replaces controller 212 of FIG. 2A). The second controller circuitry 300 may operate similarly to the controller circuitry 115, except as discussed in more detail below.

In the example of FIG. 3, the phase estimation circuitry 340 is coupled to the ADCs 204 and 208 and the controller 380. The phase estimation circuitry 340 is configured to estimate a phase difference between outputs of the ADCs 204 and 208, such that the phase estimation circuitry 340 determines an estimate of the phase difference between the current and the voltage measured by the IN sensing circuitry 135. The phase estimation circuitry 340 may compare amplitudes of the outputs of the ADCs 204 and 208 to determine a difference in a location of the waveform sampled by the S/H circuitry 202 and 206. For example, the phase estimation circuitry 340 may determine a 180 degree phase difference between current and voltage being supplied to the supply conductors 105A and 105B by determining the amplitudes of the outputs of the ADCs 204 and 208 are inverse, such that the magnitudes of the supply conductors 105A and 105B are equal while one is positive and the other is negative. The phase estimation circuitry 340 is configured to output the estimate of an angle between the current and the voltage measurements.

The controller 380 is coupled to the phase estimation circuitry 340. The controller 380 may be configured to determine the excitation frequency based on a frequency sweep, described above in connection to the controller 212 of FIG. 2A, and/or the estimated phase difference. The controller 380 is configured to maximize real power and minimize reactive power contributions to power supplied to the transducer 150 as a result of minimizing the estimated phase difference. The controller 380 may modify the excitation frequency based on the estimated phase difference. For example, the controller 380 may change (e.g., increase) the excitation frequency to shift the phase difference from a negative phase difference towards an approximately (preferably exactly) zero phase difference for transducers that are a resistive load. In such an example, the reactive power is minimized as the phase difference approaches zero. The controller 380 may change (e.g., increase) the frequency of the excitation frequency to shift the phase difference from a negative phase difference to modify the phase difference to approach zero for transducers that act as a capacitive load. In the example of the capacitive load, the reactive power is reduced.

Advantageously, the controller 380 may determine a variation in the impedance of the transducer 150 as a result of determining a shift in the estimated phase difference, such that the variation in impedance modifies the frequency response of power being supplied at the excitation frequency. Advantageously, the second controller circuitry 300 decreases the integration complexity of the power regulator 105 of FIGS. 1 and 2 as a result of using the phase estimation circuitry 340 to determine an excitation frequency that reduces the magnitude of the phase difference.

FIG. 4 are illustrative examples of waveforms generated by the power regulator 105 of FIGS. 1, 2A, and 2B to power the lens cover system 110 of FIG. 1. In the example of FIG. 4, the waveforms include a triangular signal 410, an excitation signal 420 (V_{D}[n]), a first PWM signal 430, a second PWM signal 440, and a square wave signal 450. The signals 410-450 are illustrative representations of signals generated by the power regulator 105 over an example duration of time.

The triangular signal 410 illustrates an example of the carrier signal (F_{C}) received at the carrier frequency input 216A of FIGS. 2A and 3. A frequency of the triangular signal 410 may be referred to as the carrier frequency. The triangular signal 410 is configured to be used by the PWM generator 216 of FIGS. 2A and 3 to generate the first PWM signal 430 of a varying duty cycle. The frequency of the triangular signal 410 is greater than the frequency of the excitation signal 420 to enable the duty cycle of the first PWM signal 430 to vary the duty cycle enough to avoid harmonics on the first PWM signal 430.

The excitation signal 420 is generated by the signal generator 214 of FIGS. 2 and 3. The excitation signal 420 is generated based on an amplitude and excitation frequency. The amplitude and the excitation frequency are determined by the controller 212 of FIG. 2A or the controller 380 of FIG. 3 to supply power to the lens cover system 110 of a desired magnitude. The excitation signal 420 may be a sinusoidal waveform of the amplitude and excitation frequency.

The first PWM signal 430 is generated by the PWM generator 216 by comparing the triangular signal 410 and the excitation signal 420. For example, the first PWM signal 430 is equal to a logic high for durations of time where the excitation signal 420 is greater than the triangular signal 410. In such an example, the first PWM signal 430 is equal to a logic low for durations of time where the excitation signal 420 is less than the triangular signal 410. The first PWM signal 430 may be supplied to the first pre-driver conductor 218A of FIGS. 2A, 2B, and 3. The first PWM signal 430 includes a varying duty cycle as a result of the carrier frequency, the frequency of the triangular signal 410, being not equal to the excitation frequency, the frequency of the excitation signal 420. Advantageously, the varying duty cycle of the first PWM signal 430 cause variations in pressures generated by the transducer 150 of FIG. 1, which may increase cleaning efficiency.

The second PWM signal 440 is an inverse of the first PWM signal 430. The second PWM signal 440 is generated by the pre-driver circuitry 218 of FIGS. 2A and 3 at the second pre-driver conductor 218B of FIGS. 2A, 2B, and 3. The second PWM signal 440 may be generated as a result of inverting the first PWM signal 430 or by comparing the signals 410 and 420 opposite of the comparison used to generate the first PWM signal 430, such that the second PWM signal 440 is a logic high when the triangular signal 410 is greater than the excitation signal 420.

The square wave signal 450 is generated by the amplifier circuitry 120 of FIGS. 1 and 2B. The square wave signal 450 is an illustrative example of the signal used to power the lens cover system 110. A duration of time corresponding to transitions from maximum to minimum or minimum to maximum voltages of the square wave signal 450 may be increased by the filter circuitry 125 to generate a signal resembling a sinusoidal signal. For example, the inductors 234 and 238 and the first capacitor 236 of FIG. 2B of the filter circuitry 125 may be sized to extend the duration of time corresponding to transitions from a maximum to minimum voltage or a minimum to maximum voltage. The square wave signal 450 is a differential signal, such that the voltage of the square wave signal 450 represents the potential difference between the supply conductors 105A and 150B.

FIG. 5 is a flowchart representative of an example method 500 that may be performed using machine readable instructions that can be executed and/or hardware configured to implement the lens cleaning system 100 of FIG. 1, and/or, more generally, the controller circuitry 115 of FIGS. 1 and 2 to modify power supplied to increase efficiency. At block 510, the controller circuitry 115 generates an excitation signal to supply power to the transducer 150 of FIG. 1. The controller circuitry 115 determines an amplitude and an excitation frequency of the excitation signal 420 of FIG. 4 to generate the PWM signal 430 and 440 which correspond to supply power of a target magnitude to the lens cover system 110. The excitation frequency of the PWM signal causes the transducer 150 of FIG. 1 to remove the contaminants 160 of FIG. 1 as a result of the transducer 150 converting the excitation frequency into a vibration.

At block 520, the controller circuitry 115 measures a current supplied to the transducer 150 using the second S/H circuitry 206 of FIGS. 2A and 3 to sample the signal (e.g., a voltage representative of a voltage drop across resistor 130) at the second measurement conductor 206A of FIGS. 2A and 3. The controller circuitry 115 may be configured to convert an analog voltage measurement of the second measurement conductor 206A to a digital output as a result of the second S/H circuitry 206 holding the analog voltage for a duration greater than the duration required by the second ADC 208 of FIGS. 2A and 3 to determine a digital representation. The controller circuitry 115 may be configured to determine the current supplied to the transducer 150 as a result of dividing the voltage at second measurement conductor 206A by a resistance of the resistor 130 of FIGS. 1 and 2B.

At block 530, the controller circuitry 115 measures a voltage supplied to the transducer 150 using the first S/H circuitry 202 of FIGS. 2A and 3 to sample a voltage at the first measurement conductor 202A of FIGS. 2A and 3. The voltage at the first measurement conductor 202A is representative of a potential difference across the supply conductors 105A and 105B of FIGS. 1 and 2B. The voltage at conductor 202A may be at a voltage level that is higher than the voltage level of controller circuitry 115, so the IN sensing circuitry 135 may step down the voltage from a power domain of the lens cover system 110 to a power domain (e.g., voltage level) for controller circuitry 115. The controller circuitry 115 may be configured to convert an analog voltage measurement of the first measurement conductor 202A to a digital output as a result of the first S/H circuitry 202 holding the analog voltage for a duration greater than the duration required by the first ADC 204 of FIGS. 2A and 3 to determine a digital representation.

At block 540, the controller circuitry 115 estimates power being delivered to the transducer 150 based on measurements of the current and the voltage from blocks 520 and 530. For example, the power estimation circuitry 210 of FIGS. 2A and 3 may multiply a digital representation of the measured current and a digital representation of the measured voltage to determine an estimate of power being delivered to the lens cover system 110.

At block 550, the controller circuitry 115 determines whether the estimated power, determined at block 540, is equal to the power supplied by the PWM signal generated at block 510. The estimated power is the value determined at block 540 by a multiplication of the current and the voltage measurements from blocks 520 and 530. The power supplied by the PWM signal is a value representative of the target power to be supplied as a result of the excitation signal. The power supplied by the PWM signal may be determined based on values stored in memory, such values may be determined as a part of a calibration process or pre-processing of previous estimated power values. The controller circuitry 115 determines the power supplied by the PWM signal based on whether the excitation signal is approximately (preferably exactly) equal to the target magnitude of power to be delivered to the transducer 150 to vibrate the contaminants 160. The controller circuitry 115 may determine a power factor by dividing the estimated power by the power supplied by the PWM signal. For example, the controller 212 of FIG. 2A may divide the estimated power supplied to the supply conductors 105A and 105B from the power estimation circuitry 210 by the power generated by the PWM signal. In such an example, a power factor approximately (preferably exactly) equals to one, thereby representing one-hundred percent efficiency (e.g., the estimated power is equal to the power supplied). Alternatively, the controller circuitry 115 may be configured to compare the estimated power to the power supplied using another comparison, such as a subtraction of power values (e.g., Equation 3, above), an equal to comparison operation, etc. The controller circuitry 115 may determine variations in the impedance of the transducer 150 by determining a variation in the efficiency of the power being supplied or by dividing the current provided by the voltage provided (e.g., as measured/determined by IN sensing circuitry 135, power estimation circuitry 210, phase estimation circuitry, controller 212 and/or controller 380). The controller circuitry 115 proceeds to block 510 as a result of determining that the estimated power is approximately equal to the power supplied. The method 500 proceeds to block 560 as a result of determining the difference between the estimated power and the power supplied is not zero or approximately zero.

At block 560, the controller circuitry 115 modifies the excitation frequency of the power being supplied based on the differences between the estimated power and the power supplied. The controller circuitry 115 may be configured to change the excitation frequency to a pre-determined excitation frequency to correct for the difference in the estimated power and the supplied power. For example, the controller 212 of FIG. 2A may determine the excitation frequency as a result of selecting a frequency from a plurality of frequencies corresponding to different potential contaminants, such that a frequency corresponds to one or more of the contaminants. In such an example, the plurality of frequencies may be determined and/or selected at the time of manufacture, such that the controller 212 may select a frequency opposed to performing a frequency sweep, as described above. The controller circuitry 115 may be configured to perform a frequency sweep, as described above, by incrementing or decrementing the excitation frequency. The controller circuitry 115 proceeds to block 510, such that the PWM signal generated by at block 510 uses the excitation frequency determined at block 560.

Although example methods are described with reference to the flowchart illustrated in FIG. 5, many other methods of increasing power efficiency and/or optimizing power being supplied by modifying an excitation frequency of power being supplied to the transducer 150 may alternatively be used in accordance with this description. For example, the order of execution of the blocks may be changed, and/or some of the blocks described may be changed, eliminated, or combined. Similarly, additional operations may be included in the manufacturing process before, in between, or after the blocks shown in the illustrated examples.

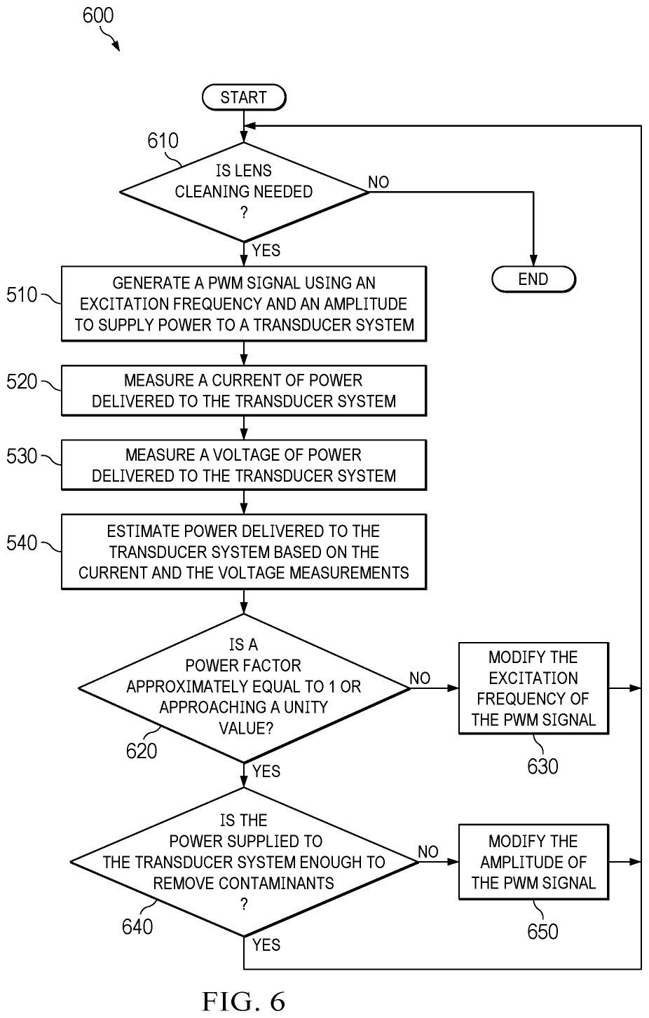

FIG. 6 is a flowchart representative of an example method 600 that may be performed using machine readable instructions that can be executed and/or hardware configured to implement the lens cover system 110 of FIG. 1, and/or, more generally, the controller circuitry 115 of FIGS. 1 and 2 (or the second controller circuitry 300 of FIG. 3) to modify power supplied, increase efficiency, and optimize removing the contaminants 160 of FIG. 1 by modifying an amplitude and/or an excitation frequency of power supplied to the transducer 150 of FIG. 1.

At block 610, the controller circuitry 115 determines whether lens cleaning is needed or not. The controller circuitry 115 may determine that cleaning of the lens cover system 110 is not needed during durations that the photo diode 175 of FIG. 1 is not being used to capture an optical input. The controller circuitry 115 may determine that cleaning of the lens cover system 110 is needed as a result of determining the photo diode 175 is being used to capture the optical input. For example, the controller 212 may determine whether the photodiode is being used as a result of determining the photo diode 175 is being powered. The controller circuitry 115 proceeds to block 510 as a result of determining that the lens cover system 110 is being used and/or needed. The controller circuitry 115 proceeds to end the method 600 as a result of determining the lens cover system 110 is not being used or needed.

At block 510, the controller circuitry 115 generates a PWM signal 430 using an excitation signal 420 of an excitation frequency and an amplitude to supply power to the transducer 150. The controller circuitry 115 is configured to select the excitation frequency based on power efficiency, such that the excitation frequency may be based on the impedance of the transducer 150. The controller circuitry 115 may be configured to determine the excitation frequency using a frequency sweep, as described in FIGS. 2A, 2B, and 4, such that the frequency corresponding to the highest efficiency may be selected. The controller circuitry 115 may select the amplitude of the PWM signal based on a magnitude of power to be supplied to the transducer 150. The controller circuitry 115 may determine the amplitude based on an amplitude control using Equations (1) and (2) or by PID control using Equations (3) and (4).

At block 520, the controller circuitry 115 measures a current supplied to the transducer 150 using the second S/H circuitry 206 of FIGS. 2A and 3 and/or the second ADC 208 of FIGS. 2A and 3. The controller circuitry 115 measures the current similar to the operations of block 520 of FIG. 5.

At block 530, the controller circuitry 115 measures a voltage supplied to the transducer 150 using the first S/H circuitry 202 of FIGS. 2A and 3 and/or the first ADC 204 of FIGS. 2A and 3. The controller circuitry 115 measures the voltage similar to the operations of block 530 of FIG. 5.

At block 540, the controller circuitry 115 estimates power being delivered to the transducer based on the current and voltage measurements of blocks 520 and 530 using the power estimation circuitry 210 of FIGS. 2A and 3. The controller circuitry 115 estimates power being delivered similar to the operations of block 540 of FIG. 5.

At block 620, the controller circuitry 115 determines whether a power factor is approximately equal to or approaching 1. The controller 212 may represent power efficiency of the power regulator 105 using a power factor, which is equal to the estimated power being delivered divided by power generated by the PWM signal, generated at block 510. The controller 212 may be configured to approximate the power factor as approximately one as a result of the power factor being within a threshold value of 1. At block 610, the controller 212 may determine the unity value based on a plurality of power factors, determined by previous estimates of power being delivered, such that the power factor of the largest magnitude is selected. For example, the controller 212 may determine the unity value is 0.8 as a result of determining the largest power factor is approximately 0.8 across a frequency sweep of the excitation frequencies. The method 600 proceeds to block 630 as a result of determining the power factor is not within a threshold of 1 or approaching a unity value, or the method 600 proceeds to block 640 as a result of determining the power factor is approximately 1 or approaching the unity value.

At block 630, the controller circuitry 115 modifies the excitation frequency of the PWM signal generated at block 510. The controller circuitry 115 modifies the excitation frequency similar to the operations of block 560 of FIG. 5. The method 600 proceeds to block 610.

At block 640, the controller circuitry 115 determines whether the power supplied to the transducer 150 is enough to remove the contaminants 160. The controller circuitry 115 may be configured to determine that the contaminants 160 are not being removed as a result of determining no variation in the impedance of the transducer 150 for a duration greater than a threshold duration. Alternatively, the controller circuitry 115 may compare the target magnitude of power to be supplied by the excitation signal to the estimated power to determine whether to modify the amplitude of the excitation signal. The method 600 proceeds to block 650 as a result of determining the power being supplied to the transducer 150 may be modified to optimize removing the contaminants 160, or the method 600 proceeds to block 610 as a result of determining the power being supplied to the transducer 150 is removing the contaminants.

At block 650, the controller circuitry 115 modifies the amplitude of the PWM signal, generated at block 510. The controller circuitry 115 may determine a modified amplitude based on a process of amplitude control using Equations (1) and (2), above, or PID control using Equations (3) and (4), above. The method 600 proceeds to block 610 using the modified amplitude to generate the PWM signal.

Although example methods are described with reference to the flowchart illustrated in FIG. 6, many other methods of increasing power efficiency by modifying an excitation frequency and amplitude of power being supplied to the transducer 150 may alternatively be used in accordance with this description. For example, the order of execution of the blocks may be changed, and/or some of the blocks described may be changed, eliminated, or combined. Similarly, additional operations may be included in the manufacturing process before, in between, or after the blocks shown in the illustrated examples.

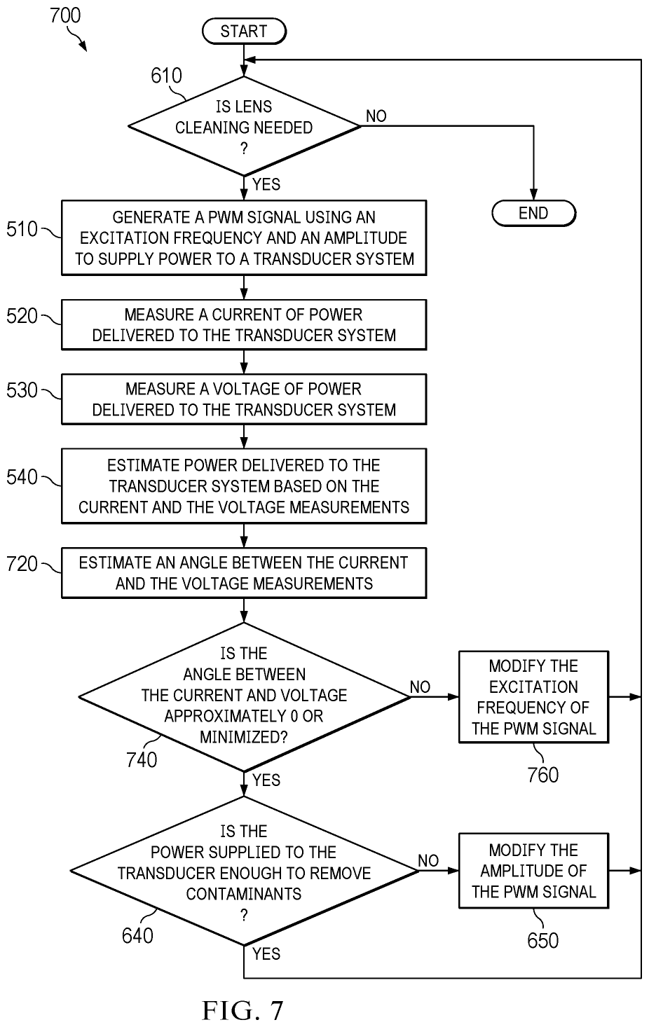

FIG. 7 is a flowchart representative of an example method 700 that may be performed using machine readable instructions that can be executed and/or hardware configured to implement the lens cleaning system of FIG. 1, and/or, more generally, the second controller circuitry 300 of FIG. 3 to modify power supplied to increase efficiency and remove contaminants.

At block 610, the second controller circuitry 300 determines whether cleaning of the lens cover system 110 is needed. The second controller circuitry 300 determines whether cleaning of the lens cover system 110 is needed similar to the operations of block 610 of FIG. 6, unless otherwise stated. The second controller circuitry 300 proceeds to block 510 as a result of determining that the lens cover system 110 is being used and/or needed. The second controller circuitry 300 proceeds to end the method 700 as a result of determining the lens cover system 110 is not being used or needed.

At block 510, the second controller circuitry 300 generates a PWM signal of an excitation frequency and an amplitude to supply power to the transducer 150 of FIG. 1 of a target magnitude. The second controller circuitry 300 is configured to select the excitation frequency based on power efficiency, such that the excitation frequency may be based on the impedance of the transducer 150. The controller circuitry 115 may be configured to determine the excitation frequency using a frequency sweep, as described in FIGS. 2A and 4, such that the frequency that has the highest efficiency may be selected. The second controller circuitry 300 may select the amplitude of the PWM signal based on a magnitude of power to be supplied to the transducer 150. The second controller circuitry 300 may determine the amplitude based on an amplitude control using Equations (1) and (2) or by PID control using Equations (3) and (4).

At block 520, the second controller circuitry 300 measures a current supplied to the transducer 150 using the second S/H circuitry 206 and/or the second ADC 208. The second controller circuitry 300 measures the current similar to the operations of block 520 of FIG. 5, unless otherwise stated.

At block 530, the second controller circuitry 300 measures a voltage supplied to the transducer 150 using the first S/H circuitry 202 and/or the first ADC 204. The second controller circuitry 300 measures the voltage similar to the operations of block 530 of FIG. 5, unless otherwise stated.

At block 540, the second controller circuitry 300 estimates power being delivered to the transducer based on the current and voltage measurements of blocks 520 and 530 using the power estimation circuitry 210 of FIGS. 2A and 3. The second controller circuitry 300 estimates power being delivered similar to the operations of block 540 of FIG. 5, unless otherwise stated.

At block 720, the second controller circuitry 300 estimates a phase difference between the current and the voltage measurements, determined at blocks 520 and 530, using the phase estimation circuitry 340 of FIG. 3. For example, the phase estimation circuitry 340 may estimate a phase difference between the voltage measurement from the first ADC 204 and the current measurement from the second ADC 208. The estimated phase difference may be represented as an angle between the current measurement of block 520 and the voltage measurement of block 530, such that the current and the voltage measurement may be illustrated as vectors by real power (x-axis) and reactive power (y-axis) contributions. The estimated angle may be used to determine a real power value and a reactive power, such that the controller 380 of FIG. 3 may decrease the power loss to the reactive power.

At block 740, the second controller circuitry 300 determines whether the estimated phase difference, determined at block 720, is approximately zero or minimized. The controller 380 may determine that the estimated phase difference is approximately zero based on determining that the estimated phase difference is within a threshold value of zero. The method 700 proceeds to block 760 as a result of determining the estimated phase difference is not approximately zero or not a minimum value. The method 600 proceeds to block 630 as a result of determining that the estimated phase difference is approximately zero or the minimum value.

At block 760, the second controller circuitry 300 modifies the excitation frequency of the PWM signal, generated at block 510. The method 600 proceeds to block 610, using a PWM signal having an excitation frequency modified at block 760.

At block 640, the second controller circuitry 300 determines whether the power supplied to the transducer 150 is sufficient (e.g., great enough to remove the contaminants 160). The second controller circuitry 300 may modify the power supplied to the transducer 150 similar to the operations of block 640 of FIG. 6. The method 700 proceeds to block 650 as a result of determining the power being supplied to the transducer 150 may be modified to optimize removing the contaminants 160 or to ensure the target magnitude of power is being supplied. The method 700 proceeds to block 610 as a result of determining the power being supplied to the transducer 150 is removing the contaminants.

At block 640, the second controller circuitry 300 modifies the amplitude of the PWM signal, generated at block 510, similar to the operations of block 640 of FIG. 6. The method 700 proceeds to block 610 using the modified amplitude to generate the PWM signal.

Although example methods are described with reference to the flowchart illustrated in FIG. 7, many other methods of increasing power efficiency by modifying an excitation frequency and amplitude of power being supplied to the transducer 150 may alternatively be used in accordance with this description. For example, the order of execution of the blocks may be changed, and/or some of the blocks described may be changed, eliminated, or combined. Similarly, additional operations may be included in the manufacturing process before, in between, or after the blocks shown in the illustrated examples.

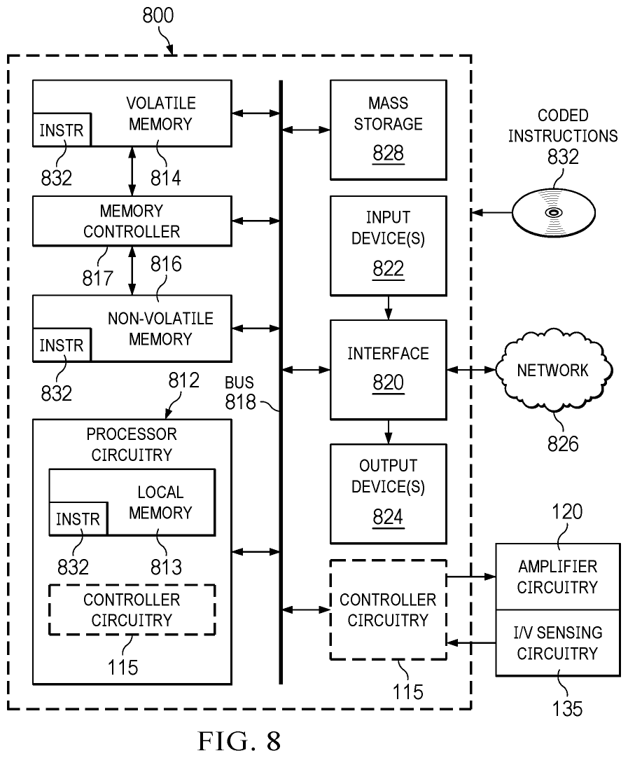

FIG. 8 is a block diagram of an example processing platform including processor circuitry structured to execute the example machine readable instructions and/or the example operations of FIGS. 5-7 to implement the power regulator of FIGS. 1 and 2. The processor platform 800 can be, for example, a server, a personal computer, a workstation, a self-learning machine (e.g., a neural network), a mobile device (e.g., a cell phone, a smart phone, a tablet such as an iPad™), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 may implement the controller circuitry 115 of FIGS. 1 and 2 or the second controller circuitry 300 of FIG. 3 (not illustrated).

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. The controller circuitry 115 may be coupled to the bus 818, such that the controller circuitry 115 is coupled between the bus 818 and the circuitry 120 and 135 of FIGS. 1 and 2B.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 832, which may be implemented by the machine readable instructions of FIGS. 5-7, may be stored in the mass storage device 828, in the volatile memory 814, in the non-volatile memory 816, and/or on a removable non-transitory computer readable storage medium such as a CD or DVD.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g., NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described embodiments, and other embodiments are possible, within the scope of the claims.

What is claimed is:

1. A power regulator operable to provide power to a transducer via a regulator output, the power regulator comprising:
filter circuitry including a filter input and a filter output, the filter output coupled to the regulator output;
amplifier circuitry including an amplifier input and an amplifier output, the amplifier output coupled to the filter input;
sensing circuitry including a sensing input and a sensing output, the sensing input coupled to the filter output and the regulator output; and
a controller including a controller input coupled to the sensing output and including a controller output coupled to the amplifier input, the controller configured to:
supply an excitation signal to the amplifier circuitry to cause the amplifier circuitry to supply the power based on the excitation signal;
estimate a magnitude of the power based on measurements of current and voltage at the filter output; and
modify the excitation signal based on the estimate of the magnitude of the power.

2. The power regulator of claim 1, wherein the power regulator further includes a lens coupled to the transducer, the transducer to move the lens based on power supplied to the transducer.

3. The power regulator of claim 2, wherein the controller is further configured to generate the excitation signal as a result of determining an excitation frequency based on the lens and contaminants covering the lens, the excitation signal to be generated using a frequency equal to the excitation frequency.

4. The power regulator of claim 2, wherein the controller is further configured to:
generate the excitation signal using a first frequency;
estimate the power delivered to the transducer at the first frequency;
generate the excitation signal using a second frequency;
estimate the power delivered to the transducer at the second frequency; and
determine an excitation frequency based on a comparison of the estimate of the power delivered to the transducer at the first frequency and the second frequency.

5. The power regulator of claim 1, wherein the controller is further configured to increase the power supplied to the transducer by increasing an amplitude of the excitation signal as a result of determining the estimate of the magnitude of the power is less than the power supplied as a result of the excitation signal.

6. The power regulator of claim 1, wherein the controller is further configured to decrease the power supplied to the transducer by decreasing an amplitude of the excitation signal as a result of determining the estimate of the magnitude of the power is greater than or equal to a desired power level.

7. The power regulator of claim 1, wherein the controller is further configured to modify a frequency of the excitation signal to minimize an angle between the measurements of current and voltage of power being supplied to the transducer.

8. The power regulator of claim 1, wherein the excitation signal is a pulse width modulation (PWM) signal generated by the controller.

9. A system comprising:
an ultrasonic lens cleaner including a transducer; and
power regulator circuitry coupled to the transducer, the power regulator circuitry including:
current and voltage (I/V) sensing circuitry coupled to the transducer; amplifier circuitry;
filter circuitry coupled to the amplifier circuitry and the transducer; and
controller circuitry coupled to the I/V sensing circuitry and the amplifier circuitry, the controller circuitry including:
a signal generator coupled to a controller;
a pulse width modulation (PWM) generator coupled to the signal generator and configured to be coupled to the amplifier circuitry; and
power estimation circuitry coupled to the controller and configured to be coupled to the I/V sensing circuitry.

10. The system of claim 9, wherein the I/V sensing circuitry is configured to determine a voltage and a current of an output signal from the filter circuitry, the voltage is determined as a result of measuring the voltage across the transducer, and the current is determined as a result of measuring a voltage difference across a resistor in series with the transducer.

11. The system of claim 9, wherein the controller circuitry is configured to generate an excitation signal, by the signal generator, with an excitation frequency and magnitude based on a magnitude of power to be delivered by the power regulator circuitry to the transducer.

12. The system of claim 11, wherein the controller circuitry is configured to determine, by the controller, the excitation frequency as a result of determining, by the controller, a frequency of the excitation signal which cause contaminants, covering a lens, to vibrate off of the lens.

13. The system of claim 9, wherein the controller circuitry is configured to modify power supplied to the transducer based on an angle between a current and a voltage measurement, measured using the I/V sensing circuitry, the angle between the current and the voltage measurement to represent a power factor of the power supplied by the amplifier circuitry and the power determined using the current and voltage measurement.

14. The system of claim 13, wherein the controller circuitry is configured to modify power delivered to the transducer by modifying the angle between the current and the voltage measurement, the controller circuitry may increase power supplied to the transducer as a result of decreasing the angle between the current and the voltage measurement.

15. The system of claim 9, wherein the amplifier circuitry is configured to supply power to the transducer as a result of generating an output signal, the output signal is determined based on an excitation signal including a frequency and amplitude.

16. A method of operating a transducer, the method comprising:
generating, by amplifier circuitry, an output signal, based on an excitation signal, operable to provide power to the transducer;
measuring, by current and voltage (IN) sensing circuitry, a current supplied to the transducer;
measuring, by the IN sensing circuitry, a voltage supplied to the transducer;
estimating, by a controller circuitry, a magnitude of power delivered to the transducer based on the current and the voltage supplied to the transducer;
modifying, by the controller circuitry, an amplitude of the excitation signal as a result determining a difference between power being generated by the excitation signal and a desired power level;
estimating, by the controller circuitry, a phase difference between the current and the voltage measurements; and
modifying, by the controller circuitry, a frequency of the excitation signal based on the phase difference.

17. The method of claim 16, wherein the method further includes determining the frequency of the excitation signal as a result of determining the frequency of the excitation signal that reduces a difference between power being generated by the excitation signal and a desired power level.

18. The method of claim 16, wherein the method further includes determining an amplitude of the excitation signal as a result of determining the amplitude of the excitation signal that reduces a difference between power being generated by the excitation signal and a desired power level.

19. The method of claim 16, wherein the method further includes increasing the power supplied to the transducer by increasing an amplitude of the excitation signal as a result of determining the magnitude of power delivered to the transducer is less than a desired power level.

20. The method of claim 16, wherein the method further includes decreasing the power supplied to the transducer by decreasing the amplitude of the excitation signal as a result of determining an estimation of the power delivered to the transducer is greater than or equal to a threshold value.

21. The method of claim 20, wherein the method further includes increasing an efficiency of the output signal as a result of minimizing an angle between the current and voltage supplied to the transducer.
